(19) United States
(12) Patent Application Publication
(10) Pub. No.: US 2002/0039630 A1
(43) Pub. Date: Apr. 4, 2002

(54) Container and method of making same

(76) Inventors: Guilhem Rousselet, Paris (FR); Jean C.A. Engels, SV Sittard (NL); Guido P.C. Beusen, AA Schimmert (NL)

Correspondence Address: Thomas L. Irving, FINNEGAN, HENDERSON, FARABOW,, GARRETT & DUNNER, L.L.P., 1300 I Street, N.W., Washington, DC, 20005-3315, US

(21) Appl. No.: 09/960,977

(22) Filed: Sep. 25, 2001

(30) Foreign Application Priority Data
Sep. 25, 2000 (FR) 0012155
May 21, 2001 (FR) 0106658

(51) Int. Cl. B32B 1/02; B29C 49/04; B29C 49/06; B29C 49/22; B29D 22/00

(52) U.S. Cl. 428/35.7; 264/513; 264/515; 264/537; 264/540

(57) ABSTRACT

A container comprises a wall comprising at least one layer, the wall comprising a polypropylene having a high flexural modulus and a polyethylene chosen from low-density and very low-density polyethylenes. The container can further comprise a product in the container. The product is chosen from cosmetic products, food products, household products, and industrial chemistry products. A method of making the container includes extruding a parison having at least one layer, the parison including a polypropylene having a high flexural modulus and a polyethylene chosen from low-density and very low-density polyethylenes, and blowing the parison in a mold having at least one cavity with a geometry corresponding to that of the container to obtain the container.

The present invention relates to a container, for example in the form of a tube, a bottle-tube, a can, or a bottle, such as one able to be used for packaging a large number of household, food, chemical, or cosmetic products.

One consideration in the design of this type of container includes its breaking strength. In particular, the material constituting such a container should be such that when it drops from the height at which it is generally found, such as from a consumer's hands or from a work surface, it does not break.

Furthermore, the material should be such that the container has axial rigidity sufficient to withstand, without being crushed, the axial pressure necessary, where appropriate, for fitting by snap-fastening a dispensing cap or head on the container. Such axial rigidity is also important when, during their storage and their transportation, the containers are stacked on pallets.

In addition, the material should be such that the container can be manufactured using commonly employed industrial manufacturing techniques, such as injection-blow molding, blow extrusion, or coextrusion. For this purpose, especially within the context of such a blow extrusion process, the material should be able to be welded, for example in a region located at the bottom of the parison.

Finally, the manufacturing cost of such a container should be sufficiently low so as to be compatible with the economic imperatives of mass distribution channels.

Conventional bottles, especially for the packaging of cosmetic products, are produced in the form of a monolayer structure based on a polypropylene copolymer, the flexural modulus of which is typically about 800 MPa. As an example, mention may be made of the material sold under the brand name BOREALIS (reference CHC 307 MO) by the company BOREALIS. Because of the relatively high flexibility of such a material, it is necessary to have a wall with a sufficiently large thickness in order to give the container the needed degree of axial strength. Typically, such a mean thickness is about 800 μm. Of course, the cost of the container will be higher when the larger the amount of raw material required for manufacture is larger.

It is also known to produce such bottles based on polyethylene, such as materials sold by the company DSM under the brand name STAMYLAW (references HD 7625 or HD 8621). These materials can pose the same problems as those mentioned with reference to the polypropylene copolymer. Typically, with this type of material, the wall thickness is about 1 mm.

For other applications, especially in the food, household, or industrial chemistry field, the wall thickness may range up to 5 mm, or even more. For these other applications, the volume of the container may range up to 50 liters or more.

One of the optional objects of the invention is, therefore, to produce a container, for example of the bottle, tube, or can type, which solves at least one of the problems discussed above with reference to the conventional materials.

In particular, it is an optional object of the invention to provide such a container that has an overall improved breaking strength and is sufficiently rigid axially, especially to withstand stacking, or to allow a dispensing cap or head to be snap-fastened onto it.

It is a further optional object of the invention to provide such a container which, with mechanical properties preserved, or even improved (especially in terms of breaking strength and axial rigidity) over conventional containers, allows the use of a smaller amount of material.

It is yet another optional object of the invention to produce such a container with a manufacturing cost sufficiently low so as to be compatible with the economic imperatives of mass distribution channels and which can be manufactured using the industrial techniques known for the manufacture of hollow articles, such as rotomolding or any type of blow molding, including injection-blow molding, blow extrusion, or blow coextrusion.

Still other optional objects will become apparent from the detailed description that follows.

According to an optional aspect of the invention, a container may include a wall comprising at least one layer, the wall comprising a polypropylene (“a polypropylene” as defined herein means at least one polypropylene) having a high flexural modulus and a polyethylene (“a polyethylene” as defined herein means at least one polyethylene) chosen from low-density polyethylenes and very low-density polyethylenes, as defined below.

According to another optional aspect of the invention, the low-density and very low-density polyethylenes may be blended with a polypropylene having a high flexural modulus. This blend may be within the same layer or may be a layer separate from the layer containing the polypropylene having a high flexural modulus.

The polypropylene may be chosen from homopolymers and copolymers having a suitable flexural modulus. The homopolymers and copolymers may be blended with at least one filler.

Surprisingly, the inventors have discovered that adding a polyethylene chosen from low-density and very low-density polyethylenes to a polypropylene having a high flexural modulus, such as to a polypropylene homopolymer, can improve the breaking strength of the container much more than it degrades the property of axial rigidity.

The present invention, using a polypropylene having a suitable flexural modulus, goes counter to the approaches which have commonly been adopted hitherto in the bottle-making field and which generally favor the use of a polypropylene having a lower flexural modulus.

Compared with a bottle made only of a polypropylene having a high flexural modulus, the container obtained according to an optional aspect of the invention can have a substantially improved breaking strength, while the axial strength is not appreciably affected. Thus, for identical or even superior performance in terms of breaking strength and axial strength, the amount of material required can be lower than that required with conventional materials. The manufacturing cost of the container is therefore correspondingly reduced.

With regard to the breaking stress, a test known as a “drop test” may be used. This test is described in detail below with reference to specific examples.

With regard to the axial strength, a test known as a “constantrate-compression test” may be used. This test measures the force resulting in a predetermined depression of the bottle. To do this, a tensile tester is used, this being set up to apply compression at a rate of approximately 60 mm/min. The force needed to obtain the depression is measured.

For the same, or even improved, mechanical properties, such as breaking strength and axial rigidity, the amount of material for a bottle according to one optional aspect of the invention can range from about 5 to 50%, such as from 10 to 30%, less than that required for the same bottle produced in a conventional manner.

As used herein, “high flexural modulus” means a flexural modulus greater than 1200 MPa. In one optional embodiment, the flexural modulus may be greater than 1500 MPa. In a further optional embodiment, the flexural modulus may be greater than 1800 MPa. In a still further optional embodiment, the flexural modulus may be greater than 2000 MPa. Such a flexural modulus can be measured according to the ISO 178 standard.

In one illustrative example, a polypropylene homopolymer whose flexural modulus is 2150 MPa, sold by the company MONTELL under the reference ADSTIF 680 ADXP, is used.

In a further illustrative example, a polypropylene homopolymer sold by the company DSM under the brand name STAMYLAN (reference P15 EK10) is used. The flexural modulus of this particular material is 2050 MPa.

In a still further illustrative example, a polypropylene homopolymer sold by the company DSM under the brand name STAMYLAN (reference P12 E62) is used. The flexural modulus of this particular material is 1500 MPa.

In yet another illustrative example, a polypropylene copolymer sold by the company DSM under the brand name STAMYLAN (reference P83 E10N) is used. The flexural modulus of this particular material is 1350 MPa.

In one optional embodiment, the polypropylene may have a degree of crystallinity greater than 40%. In a further optional embodiment, the polypropylene may have a degree of crystallinity greater than 50%. In a still further optional embodiment, the polypropylene may have a degree of crystallinity greater than 60%. The crystallinity of the polypropylene homopolymer may be increased by means of a nucleating agent, such as the product MILLAD sold by the company MILLIKEN.

In another optional embodiment, the high flexural modulus of the polypropylene may be obtained by adding at least one filler, for example, in an amount of 5 to 50% by weight, based on the total weight of the at least one filler and a standard polypropylene, to a standard polypropylene, i.e, one having a flexural modulus of less than 1200 MPa. In another illustrative example, an amount of 10 to 40% by weight, based on the total weight of the at least one filler and a standard polypropylene, may be added. Such fillers are chosen from those commonly used for this purpose and may be chosen from glass fibers, talc, chalk, or barium sulfate. Manufacture may begin with a polypropylene having a conventional flexural modulus of less than 1200 MPa, to which the suitable filler or fillers are added at the moment of extrusion.

As used herein, the term “polyethylene” includes both ethylene homopolymers and copolymers. For example, representative ethylene copolymers are chosen from copolymers of ethylene with up to b 35% by weight, based on the total weight of the copolymer, of at least one 1-alkene, such as one containing 3 to 10 carbon atoms. The polyethylene may be linear or branched.

As used herein, the term “low-density polyethylene” means a polyethylene whose density ranges from 0.905 g/cm³ to about 0.930 g/cm³. A representative low-density polyethylene is sold by the company EXXON under the brand name EXCEED, having a density greater than 0.905 g/cm³. The density can be measured according to the ISO standard 1183.

In one optional embodiment, a very low-density polyethylene may be used. As used herein, “very low-density polyethylene” means a polyethylene whose density is less than 0.905 g/cm³; in other words, below that of low-density polyethylene as defined herein. For example, the density of a very low-density polyethylene may be greater than 0.850 g/cm³ and, of course, less than 0.905 g/cm³. In another example, the density of a very low-density polyethylene may be greater than about 0.875 g/cm³ and less than 0.905 g/cm³.

The low-density and very low-density polyethylenes may be obtained by catalysis using a catalyst having a high reaction selectivity. A “catalyst having a high reaction selectivity”, as used herein, means a catalyst involving only a single type of reaction site. One illustrative example is the metallocene type catalyst. Using catalysts of this type, the increase in breaking strength of the container is greater than the reduction in axial rigidity.

A representative very low-density polyethylene obtained by metallocene catalysis is a material sold by the company DEX PLASTOMERS under the commercial reference EXACT 0201, the density of which is about 0.902 g/cm³.

Another example is a material sold by the company DEX PLASTOMERS under the commercial reference EXACT 8201, the density of which is about 0.882 g/cm³.

Other materials, such as those sold by the company DOW under the brand names ENGAGE, ELITE, and AFFINITY may also be used.

According to one optional embodiment of the invention, the wall may comprise a first layer comprising a blend of a polypropylene having a high flexural modulus and a polyethylene chosen from low-density and very low-density polyethylenes.

In one optional embodiment, the first layer comprises 2 to 40% by weight, based on the total weight of the first layer, of a polyethylene chosen from low-density and very low-density polyethylenes. In another optional embodiment, the first layer comprises 10 to 25% by weight, based on the total weight of the first layer, of a polyethylene chosen from low-density and very low-density polyethylenes. Too small an amount of polyethylene may not substantially improve the breaking strength of the container. Too large an amount of polyethylene may affect the axial rigidity of the container. One skilled in the art will be able to routinely select an appropriate amount for a particular application.

The container may comprise a second layer comprising a polyethylene chosen from low-density and very low-density polyethylenes. The second layer may be formed with at least 60% by weight, based on the total weight of the second layer, of such a polyethylene. In one optional embodiment, the second layer may be formed with at least 70% by weight of such a polyethylene. In a further optional embodiment, the second layer may be formed with at least 80% by weight, based on the total weight of the second layer, of such a polyethylene.

The invention contemplates an embodiment where the second layer comprises such a polyethylene but the first layer does not.

The polyethylene of the second layer may be identical to that used in the composition of the first layer. However, this is not a necessity since it may be advantageous to have different polyethylenes chosen from low-density and very low-density in the various layers to vary the properties of the various layers.

Where appropriate, the polyethylene chosen from low-density and very low-density polyethylenes in the second layer may be a blend with a polyolefin, for example polypropylene or a different polyethylene of lower cost, further reducing the cost of the container. However, in this optional embodiment, polyethylene chosen from low-density and very low-density polyethylenes must be the predominant component in the blend (as used herein, “predominant” means highest in amount). In one optional embodiment, the polyethylene chosen from low-density and very low-density polyethylenes may range from 60% to 98% by weight based on the total weight of the layer. In a further optional embodiment, the polyethylene chosen from low-density and very low-density polyethylenes may range from 75% to 90% by weight based on the total weight of the layer.

The second layer may be placed either on the inside of the container, or on the outside. Arrangement of the second layer on the inside of the container, however, may make it possible to obtain a higher breaking strength than if the second layer were on the outside of the container.

Furthermore, the wall of the container may include a third layer comprising a polyethylene chosen from low-density and very low-density polyethylenes, the first layer being placed between the second and third layers. In one optional embodiment, the third layer may be formed with at least 60% by weight, based on the total weight of the third layer, from a polyethylene chosen from low-density and very low-density polyethylenes. In a further optional embodiment, the third layer may be formed with at least 70% by weight, based on the total weight of the third layer, from a polyethylene chosen from low-density and very low-density polyethylenes. In a still further optional embodiment, the third layer may be formed with at least 80% by weight, based on the total weight of the third layer, from a polyethylene chosen from low-density and very low-density polyethylenes.

This third layer may further improve the breaking strength of the container without substantially affecting the flexural modulus of the assembly. Such a third layer may be desired in the case of containers of larger volume or containers whose shape makes them more sensitive to breaking.

The material forming the third layer may be identical to that forming the second layer. This characteristic favors the coextrusion process by allowing a single feed source for the material forming the second and third layers.

According to another optional embodiment, the container according to the invention may comprise a first layer formed, at least in part, from a polypropylene having a high flexural modulus and a second layer formed, at least in part, from a polyethylene chosen from low-density and very low-density polyethylenes.

The second layer may be formed with at least 60% by weight, based on the total weight of the second layer, of a polyethylene chosen from low-density and very low-density polyethylenes. In another optional embodiment, the second layer may be formed with at least 70% by weight, based on the total weight of the second layer, of a polyethylene chosen from low-density and very low-density polyethylenes. In yet another optional embodiment, the second layer may be formed with at least 80% by weight, based on the total weight of the second layer, of a polyethylene chosen from low-density and very low-density polyethylenes.

In these optional embodiments comprising a first layer formed, at least in part, from a polypropylene having a high flexural modulus and a second layer formed, at least in part, from a polyethylene chosen from low density and very low density polyethylenes, the container may further include a third layer, the first layer being placed between the second and third layers. The third layer may be formed, at least in part, from a polyethylene chosen from low-density and very low-density polyethylenes and may be identical to the second layer.

In the case of a multilayer structure within the embodiments of the invention, the polypropylene having a high flexural modulus may be in a layer representing 70 to 95% of the total wall thickness. In another optional embodiment, the polypropylene having a high flexural modulus may be in a layer representing 80 to 95% of the total wall thickness. These ranges make it possible to provide a good compromise between the breaking strength of the container and its axial rigidity.

The configuration of the multilayer container can provide a better breaking strength while maintaining the same axial rigidity as that of a container consisting of a single layer containing approximately the same amount of a polyethylene chosen from low-density and very-low density polyethylenes.

As an illustrative example, for containers of the type used in the cosmetics field, the total wall thickness may range from 450 μm to 800 μm. In another illustrative example, these containers may have a total wall thickness in a range from 500 μm to 700 μm. For other applications, for which the volume of the containers is higher, the wall thickness may range up to 5 mm, or even more. Even for these larger-volume containers, the same or improved mechanical properties may be attained with substantially less material than that required by conventional containers.

The container according to the invention can be used, for example, for the packaging of a cosmetic product, such as a hair, body hygiene, skin care or make-up product; a food product, such as a drink; a household product, such as a detergent; or an industrial chemistry product.

According to another optional aspect of the invention, there is provided a method of making a container, the method comprising extruding a parison comprising at least one layer, the parison comprising a polypropylene having a high flexural modulus and polyethylene chosen from low-density and very low-density polyethylenes, and blowing the parison in a mold having at least one cavity with a geometry corresponding to that of the container.

The parison may comprise a first layer comprising a polypropylene having a high flexural modulus and a polyethylene chosen from low-density and very low-density polyethylenes.

In an optional embodiment, extruding a parison may comprise coextruding, with the first layer, a second layer comprising a polyethylene chosen from low-density and very low-density polyethylenes, such that the second layer is inside the parison.

In another optional embodiment, extruding a parison may comprise coextruding, with the first layer and the second layer, a third layer comprising a polyethylene chosen from low-density and very low-density polyethylenes, such that the first layer is between the second layer and the third layer.

The parison may comprise a first layer comprising a polypropylene having a high flexural modulus and a second layer comprising a polyethylene chosen from low-density and very low-density polyethylenes.

Optionally, the parison may comprise a third layer, such that the first layer is between the second layer and the third layer. The third layer may comprise a polyethylene chosen from low-density and very low-density polyethylenes.

According to a further optional aspect of the invention, there is provided a method of making a container, the method comprising producing a preform by injection molding, the preform comprising a polypropylene having a high flexural modulus and a polyethylene chosen from low-density and very low-density polyethylenes, and blowing the preform into a finishing mold having at least one cavity with a geometry corresponding to that of the container.

In one optional embodiment, the parison comprises a first layer formed, at least in part, from a polypropylene having a high flexural modulus and from a polyethylene chosen from low-density and very low-density polyethylenes. The parison may comprise at least two superposed layers, the second layer being placed on the inside of the parison and at least partly comprising a polyethylene chosen from low-density and very low-density polyethylenes.

According to another optional embodiment, the parison may comprise a first layer formed, at least in part, from a polypropylene having a high flexural modulus and a second layer formed, at least in part, from a polyethylene chosen from low-density and very low-density polyethylenes. The parison may include a third layer, the first layer being placed between the second and third layers. The third layer may be formed, at least in part, from a polyethylene chosen from low-density and very low-density polyethylenes.

Aside from the arrangements set forth above, the invention could include a number of other arrangements, such as those explained hereinafter. It is to be understood that both the foregoing description and the following description are merely exemplary.

The accompanying drawings are incorporated in and constitute a part of this specification. The drawings illustrate optional embodiments of the invention and, together with the description, serve to explain some principles of the invention. In the drawings,

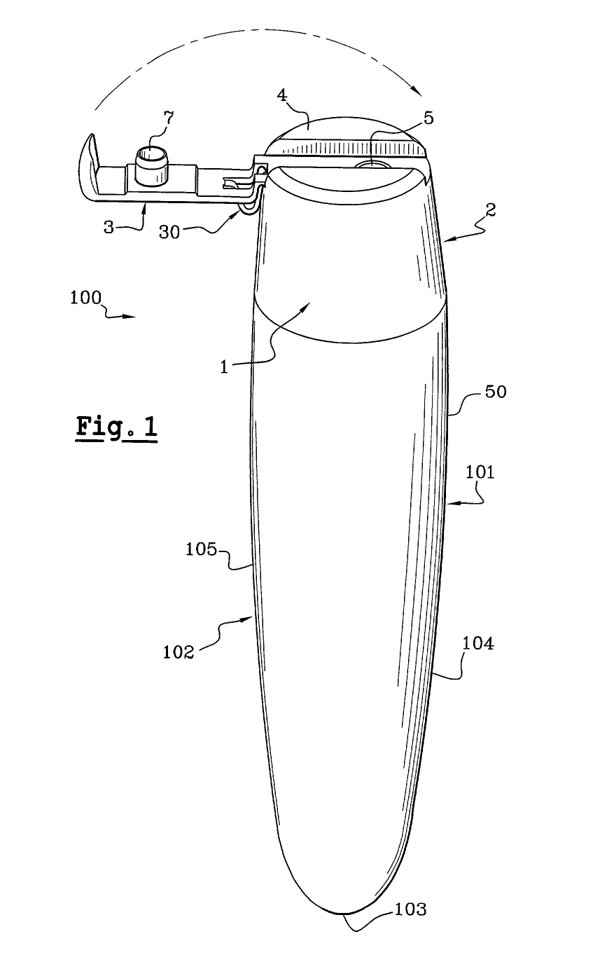

FIG. 1 shows one optional embodiment of a container according to the invention;

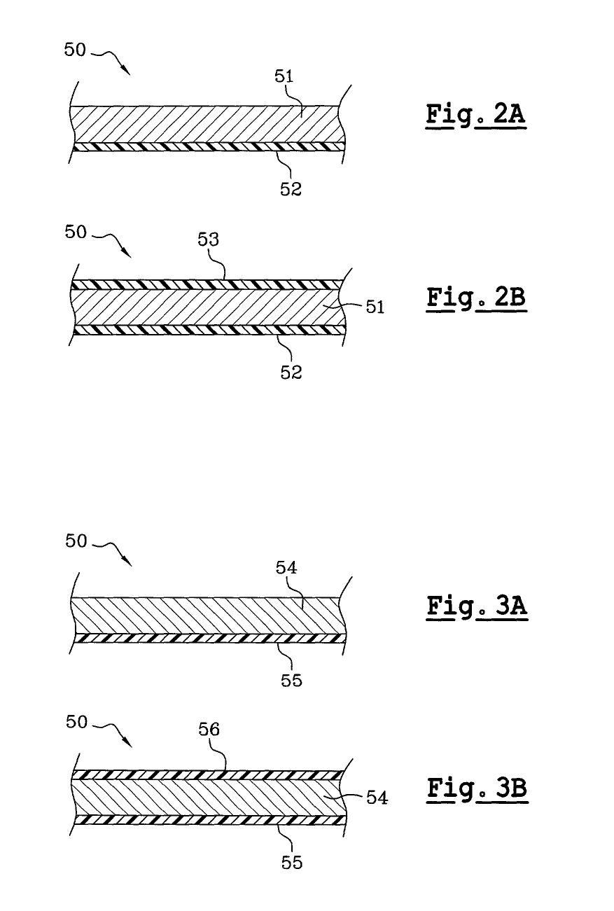

FIGS. 2A and 2B illustrate two optional embodiments of the wall of the container shown in FIG. 1; and

FIGS. 3A and 3B illustrate two additional optional embodiments of the wall of the container shown in FIG. 1.

In FIG. 1, the container 100 according to one optional embodiment of the invention comprises a bottle 101. The bottle 101 has a body 102 bounded by a wall 50 and closed by a bottom 103. The body 102 is of elongate cross section and is formed from two large faces 104, 105 which are elastically deformable in response to a pressure exerted perpendicular to the large sides of the bottle.

Snap-fastened onto the neck of the bottle is a cap 1. The cap 1 has a body 2 to which a cover 3 is articulated, via a hinge or an articulation 30 with a spring effect. The body 2 of the cap 1 has a transverse wall 4 in which a recess 5 is made, on the bottom of which an outlet orifice is formed. On its face intended to be opposite the transverse wall 4, the cover 3 has a stud 7 which can be sealingly engaged in the recess 5 so as to ensure that the closure is properly sealed.

According to a first optional embodiment, the wall 50 forming the container 100 has a thickness of about 600 μm and is formed from a single layer, comprising a blend comprising 75% by weight, based on the total weight of the blend, of a polypropylene homopolymer, the flexural modulus of which is 2050 MPa, sold by the company DSM under the brand name STAMYLAN (reference P15 EK10); and 25% by weight, based on the total weight of the blend, of a very low-density polyethylene, such as one obtained by metallocene catalysis. In this specific example, there is used a material manufactured by the company DEX PLASTOMERS under the commercial reference EXACT 0201, whose relative density is about 0.902.

The resulting container exhibits very good axial rigidity. However, for a bottle with a geometry close to that shown in FIG. 1 and/or with a volume of approximately 200 ml, a certain weakness of the container is observed at the bottom weld line. This weakness may make such a container unsuitable for certain consumer applications for which the breaking strength limit is set very high, as required for the safety of the consumer. The breaking strength, however, may be sufficient for applications having a lower consumer application requirement.

The breaking strength of the containers was measured by means of a test that involved dropping the container filled with water from a drop height of 140 cm. Higher or lower drop heights may be used, depending on the characteristics of the container, especially its volume, and depending on the strength imposed by the company marketing the container.

In the embodiment in FIG. 2A, the wall 50 forming the container 100, shown in FIG. 1, comprises two layers: a layer 51, external to the container, and a layer 52, internal to the container.

The thickness of the layer 51 is about 510 μm. The thickness of the layer 52 is about 90 μm.

The material forming the layer 51 comprises a blend formed from 85% by weight, based on the total weight of the blend, of a polypropylene homopolymer having a very high flexural modulus (ADSTIF 680 ADXP) and from 15% by weight, based on the total weight of the blend, of a very low-density polyethylene, such as one obtained by metallocene catalysis (EXACT 0201).

The material forming the layer 52 is the same very low-density polyethylene as that used in the manufacture of the layer 51.

The container 100 obtained by blow coextrusion of the two layers 51, 52 exhibits both a good breaking strength, including at the welds, and good axial rigidity.

In the embodiment in FIG. 2B, the wall 50 forming the container 100, as shown in FIG. 1, comprises three layers: a layer 53, external to the container, an interlayer 51, and a layer 52 internal to the container.

The thickness of the layers 52 and 53 is about 60 μm. The thickness of the layer 51 is about 480 μm.

The material forming the layer 51 comprises of a blend formed from 80% by weight, based on the total weight of the blend, of a polypropylene homopolymer (STAMYLAN P15 EK10) and from 20% by weight, based on the total weight of the blend, of a very low-density polyethylene, such as one obtained by metallocene catalysis (EXACT 8201).

The material forming the layers 52 and 53 is the same very low-density polyethylene as that used in the manufacture of the layer 51.

The container 100, obtained by blow coextrusion of the three layers 51, 52, 53 exhibits both good breaking strength, including at the welds, and good axial rigidity.

In the embodiment shown in FIG. 3A, the wall 50 comprises a layer 54 of a polypropylene having a high flexural modulus (STAMYLAN P15 EK10). The thickness of the layer 54 is approximately 600 μm.

The wall 50 also includes a layer 55, intended to be placed on the inside of the container, and formed from a very low-density polyethylene obtained by metallocene catalysis (EXACT 8201). The thickness of the layer 55 is approximately 66 μm.

In the embodiment shown in FIG. 3B, the wall 50 comprises layer 54 of a polypropylene having a high flexural modulus (STAMYLAN P15 EK10). The thickness of the layer 54 is approximately 600 μm.

Placed on each side of the layer 54 are two layers 55 and 56, each having a thickness of approximately 33 μm. Each layer 55, 56 is formed from a very low-density polyethylene obtained by metallocene catalysis (EXACT 8201).

The container 100 obtained for these latter two embodiments exhibits both good breaking strength and good axial rigidity.

It will be apparent to those skilled in the art that various modifications and variations can be made to the structure and methodology of the present invention. Thus, it should be understood that the invention is not limited to the examples discussed in the specification. Rather, the present invention is intended to cover modifications and variations.

What is claimed is:

1. A container comprising a wall comprising at least one layer, the wall comprising a polypropylene having a high flexural modulus and a polyethylene chosen from low-density and very low-density polyethylenes.

2. The container of claim 1, wherein the polypropylene is chosen from homopolymers.

3. The container of claim 1, wherein the polypropylene has a flexural modulus greater than 1500 MPa.

4. The container of claim 3, wherein the polypropylene has a flexural modulus greater than 1800 MPa.

5. The container of claim 3, wherein the polypropylene has a flexural modulus greater than 2000 MPa.

6. The container of claim 1, wherein the polypropylene is chosen from copolymers.

7. The container of claim 1, wherein the polypropylene has a degree of crystallinity greater than 40%.

8. The container of claim 7, wherein the polypropylene has a degree of crystallinity greater than 50%.

9. The container of claim 7, wherein the polypropylene has a degree of crystallinity greater than 60%.

10. The container of claim 1, wherein the polypropylene is in a blend with at least one filler.

11. The container of claim 10, wherein the at least one filler is chosen from glass fibers, chalk, talc, and barium sulfate.

12. The container of claim 1, wherein the polyethylene has a density of less than 0.930 g/cm³.

13. The container of claim 12, wherein the polyethylene has a density of less than 0.905 g/cm³.

14. The container of claim 12, wherein the polyethylene has a density of greater than 0.850 g/cm³ and less than 0.905 g/cm³.

15. The container of claim 14, wherein the polyethylene has a density of greater than 0.875 g/cm³ and less than 0.905 g/cm³.

16. The container of claim 1, wherein the polyethylene is obtained by a polymerization reaction comprising a catalyst having a high reaction selectivity.

17. The container of claim 16, wherein the catalyst is chosen from metallocene catalysts.

18. The container of claim 1, wherein the wall has a total thickness ranging from 450 μm to 800 μm.

19. The container of claim 18, wherein the wall has a total thickness ranging from 500 μm to 700 μm.

20. The container of claim 1, wherein the wall comprises at least two layers, one of the layers comprising the polypropylene having a high flexural modulus and representing 70 to 95% of the total thickness of the wall.

21. The container of claim 20, wherein the layer comprising the polypropylene having a high flexural modulus represents 80 to 95% of the total thickness of the wall.

22. The container of claim 1, wherein the wall comprises a layer comprising a blend of a polypropylene having a high flexural modulus and a polyethylene chosen from low-density and very low-density polyethylenes.

23. The container of claim 22, wherein the layer comprising the blend comprises 2 to 40% by weight, based on the total weight of the layer, of said polyethylene.

24. The container of claim 23, wherein the layer comprising the blend comprises 10 to 25% by weight, based on the total weight of the layer, of said polyethylene.

25. The container of claim 22, further comprising a second layer comprising said polyethylene.

26. The container of claim 25, wherein the second layer is located on the inside of the container.

27. The container of claim 25, wherein the second layer comprises said polyethylene blended with a polyolefin different from said polyethylene.

28. The container of claim 27, wherein the polyolefin is chosen from polypropylenes and polyethylenes different from said polyethylene.

29. The container of claim 25, further comprising a third layer comprising a polyethylene chosen from low-density and very low-density polyethylenes, wherein the first layer is between the second layer and the third layer.

30. The container of claim 29, wherein the second and third layers are of identical composition.

31. The container of claim 1, wherein the wall comprises a first layer comprising a polypropylene having a high flexural modulus, and a second layer comprising a polyethylene chosen from low-density and very low-density polyethylenes.

32. The container of claim 31, further comprising a third layer, wherein the first layer is between the second layer and the third layer.

33. The container of claim 32, wherein the third layer comprises a polyethylene chosen from low-density and very low-density polyethylenes.

34. The container of claim 1, further comprising a product in the container, wherein the product is chosen from cosmetic products, food products, household products, and industrial chemistry products.

35. The container of claim 34, wherein the cosmetic products are chosen from hair products, body hygiene products, skin care products, and makeup products.

36. The container of claim 34, wherein the food products are chosen from beverages.

37. The container of claim 34, wherein the household products are chosen from detergents.

38. A method of making a container comprising a wall comprising at least one layer, the wall comprising a polypropylene having a high flexural modulus and a polyethylene chosen from low-density and very low-density polyethylenes, the method comprising:
extruding a parison having at least one layer, the parison comprising a polypropylene having a high flexural modulus and a polyethylene chosen from low-density and very low-density polyethylenes; and
blowing the parison in a mold having at least one cavity with a geometry corresponding to that of the container to obtain the container.

39. The method of claim 38, wherein the parison comprises a first layer comprising a polypropylene having a high flexural modulus and a polyethylene chosen from low-density and very low-density polyethylenes.

40. The method of claim 39, wherein extruding a parison comprises coextruding, with the first layer, a second layer, comprising a polyethylene chosen from low-density and very low-density polyethylenes, such that the second layer is inside the parison.

41. The method of claim 40, wherein extruding a parison comprises coextruding, with the first layer and the second layer, a third layer comprising a polyethylene chosen from low-density and very low-density polyethylenes, such that the first layer is between the second layer and the third layer.

42. The method of claim 38, wherein the parison comprises a first layer comprising a polypropylene having a high flexural modulus and a second layer comprising a polyethylene chosen from low-density and very low-density polyethylenes.

43. The method of claim 42, wherein the parison comprises a third layer, such that the first layer is between the second layer and the third layer.

44. The method of claim 43, wherein the third layer comprises a polyethylene chosen from low-density and very low-density polyethylenes.

45. A method of making a container comprising a wall comprising at least one layer, the wall comprising a polypropylene having a high flexural modulus and a polyethylene chosen from low-density and very low-density polyethylenes, the method comprising:
producing a preform by injection molding, the preform comprising a polypropylene having a high flexural modulus and a polyethylene chosen from low-density and very low-density polyethylenes; and
blowing the preform into a finishing mold having at least one cavity with a geometry corresponding to that of the container to obtain the container.

46. The container of claim 1, wherein the polypropylene and the polyethylene comprise a blend comprising 75% by weight, based on the total weight of the blend, of a polypropylene homopolymer, and 25% by weight, based on the total weight of the blend, of a very low density polyethylene.

47. The container of claim 46, wherein the polypropylene homopolymer has a flexural modulus of 2050 MPa and the very low density polyethylene is obtained by metallocene catalysis.

48. The container of claim 46, wherein the very low density polyethylene has a relative density of about 0.902.

49. The container of claim 1, wherein the polypropylene and the polyethylene comprise a blend comprising 85% by weight, based on the total weight of the blend, of a polypropylene homopolymer, and 15% by weight, based on the total weight of the blend, of a very low density polyethylene.

50. The container of claim 49, wherein the very low density polyethylene is obtained by metallocene catalysis.

51. The container of claim 1, wherein the polypropylene and the polyethylene comprise a blend comprising 80% by weight, based on the total weight of the blend, of a polypropylene homopolymer, and 25% by weight, based on the total weight of the blend, of a very low density polyethylene.

52. The container of claim 51, wherein the very low density polyethylene is obtained by metallocene catalysis.
